(19) United States
(12) Patent Application Publication
(10) Pub. No.: US 2026/0036399 A1
(43) Pub. Date: Feb. 5, 2026

(54) Miniaturized Single Focal Plane Aiming Device

(71) Applicant: Lawrence Stein, San Diego, CA (US)

(72) Inventor: Lawrence Stein, San Diego, CA (US)

(21) Appl. No.: 19/263,808

(22) Filed: Jul. 9, 2025

Related U.S. Application Data
(62) Division of application No. 18/409,780, filed on Jan. 10, 2024.

(51) Int. Cl. F41G 11/00; F41G 1/02; F41G 1/06; F41G 1/30; F41G 1/467; F41G 3/00; G02B 23/10

(52) U.S. Cl. CPC F41G 11/00; F41G 1/02; F41G 1/06; F41G 1/30; F41G 1/467; F41G 3/00; G02B 23/105

(57) ABSTRACT

Apparatus and methods including miniaturization of a single focal plane collimated light-based aiming sights and their variants. One technical effect includes a user's ability to develop an effective, accurate and fast sight picture using ‘red-dot’/reticle type sights while preserving the superior accuracy of these technologies. One new result is the reduction of the housing size, and overall footprint of the structural elements of these sights. In at least on embodiment, using LEDs, the power requirement for the aiming device is significantly lowered which means that the volume and weight of the aiming device is reduced. Accordingly, this enables positioning of the now miniaturized sight at the top of a pistol, firearm or apparatus. In at least one embodiment an aiming device is located with a firearm's front sight. In at least one embodiment, an aiming sight's structure, methods of fabrication, assembly, use includes kitting of the sights.

### TECHNICAL FIELD

At least one embodiment pertains to aiming devices such as firearms, handguns, rifles, shotguns, machine guns, grenade launchers, bows, crossbows, pulsed or phased weapons, lasers and laser-type weapons, artillery, mortars and anti-aircraft weapons. For example, an aiming device comprising: at least one light source, at least one collimation element, and at least one housing, wherein
a) the light source generates or gathers light which is passed through a collimation element; said light passes through the collimation element is used to provide a signal used in aiming; and
b) the aiming device is miniaturized.

### BACKGROUND

Aiming devices using front and rear fixed sights, often called ‘iron’ sights are and have been useful aiming devices, but compel the user to focus their eyes on three distinct focal planes: the front sight, the rear site and the target. It is physiologically impossible to simultaneously focus sharply on more than one focal plane—it always takes an aimer a certain amount of time to shift focus. Further, if the fight-or-flight reflex is affecting a shooter (as in a defensive shooting or combat), vision may be affected in a number of ways. One is that pupils dilate making near focus more difficult or even impossible to focus one's attention on iron sights. The concentration and aiming required for iron sights can also distract a shooter/aimer's attention and suffers the drawback that aiming using irons sights is less effective at longer ranges. (Multiple Focal Planes). There exists a need to improve aiming devices.

### BRIEF DESCRIPTION OF DRAWINGS

FIG. 1 illustrates multiple views of a pistol configured with miniaturized aiming device as a front sight in accordance with at least one embodiment;

FIG. 2A and 2B illustrate multiple trimetric views of a pistol configured with a miniaturized aiming device as a front sight in accordance with at least one embodiment;

FIG. 3 illustrates multiple views of a miniaturized aiming device as a rear sight in accordance with at least one embodiment;

FIG. 4A and B illustrates trimetric views of a miniaturized aiming device as a rear sight in accordance with at least one embodiment;

FIG. 5A and B illustrates trimetric views of a pistol configured with a miniaturized aiming device as a front sight, in accordance with at least one embodiment;

FIG. 6A and B illustrates trimetric views of a pistol configured with a miniaturized aiming device as a front sight, in accordance with at least one embodiment;

FIG. 7A and B illustrates trimetric views of a rifle configured with a miniaturized aiming device as a front sight, in accordance with at least one embodiment;

FIG. 8A and B illustrates trimetric views of a rifle configured with a miniaturized aiming device as a front sight, in accordance with at least one embodiment;

FIG. 9 illustrates a trimetric view of a bow and arrow configured with a miniaturized aiming device, in accordance with at least one embodiment;

FIGS. 10 illustrates a side-view/cross section of a holographic miniaturized aiming device, in accordance with at least one embodiment;

FIG. 11 illustrates a side-view/cross section of an occluded miniaturized aiming device, in accordance with at least one embodiment;

FIG. 12 illustrates a side-view/cross section of a reflex miniaturized aiming device, in accordance with at least one embodiment;

FIG. 13A, 13B and 13C illustrate how a human brain assembles different images from each eye in an non-occluded miniaturized aiming device in accordance with at least one embodiment;

FIG. 14A, 14B and 14C illustrate how a human brain assembles different images from each eye in an occluded miniaturized aiming device in accordance with at least one embodiment;

FIG. 15 illustrates a trimetric view of a miniaturized aiming device with a see-through housing, accordance with at least one embodiment;

FIG. 16 illustrates a pistol optic size specifications for some industry pistol optics in accordance with at least one embodiment;

FIG. 17 illustrates corresponding sources for the specifications of FIG. 15, in accordance with at least one embodiment;

FIG. 18 illustrates a rifle optic size specifications for some industry rifle optics in accordance with at least one embodiment;

FIG. 19 illustrates corresponding sources for the specifications of FIG. 17, in accordance with at least one embodiment;

### DETAILED DESCRIPTION

This utility application claims priority to provisional application 63/480,102 filed at the USPTO on Jan. 16, 2023 at 11:18:30 PM ET; titled “Miniaturized Single Focal Plane Aiming Device”; said application filed pursuant to 35 USC § 111(b). This application incorporates by reference the ADS, Oath/Declaration, and Certification of Micro Entity Status, that were filed in conjunction with the provisional application filing. The confirmation number for that provisional filing is 4318 and was filed under customer number 186672. The sole inventor is Lawrence Stein and there is no joint inventor. No assignment was made or is now being made. The following statements are indicated pursuant to MPEP 608.01(a).

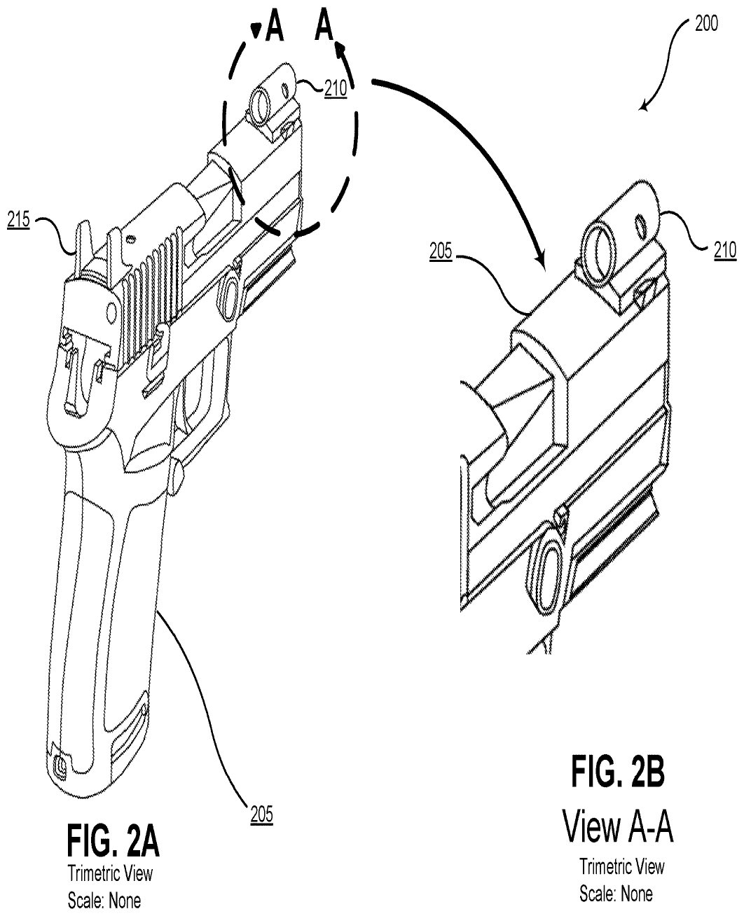

The title is: “Miniaturized Single Focal Plane Aiming Sight”. FIG. 2 is selected for use to appear on the first page of the patent publication for this application.

This submission is not, and was not a result of, nor supported by, any federally sponsored research and development.

The submission is not, and was not, part of any joint research agreement. There are no parties associated with any joint research agreement.

There is no sequence listing and there are no compact discs associated with this disclosure.

In the United States, the utility application should be examined using America Invents Act (AIA) amendments to Title 35 of the USC because there is no priority or reference by any claim to matter referenced prior to Mar. 16, 2013.

Pursuant to 35 USC § 123 (a) (2) the Applicant claims, and requests treatment as a micro entity.

A technical improvement to front and rear post ‘iron’ sights was the occluded eye gunsight by Singlepoint, now marketed by Armson USA. This sight consisted of a tube with a collimated light source at one end that was focused on to a dot. A shooter or aimer used this sight by using two eyes: one eye would look outside the sight at a target and the other eye would look into the sight. The eye looking into the sight sees only a dot and is unable to see through the distal aperture: The aimer's sight was thus ‘occluded’ in the eye looking through the sight. The human nervous system and mind unites the two separate images—one from each eye—into a single image. The occluded eye gunsight (OEG) made aiming easier because it allowed for single focal plane aiming. Collimated light essentially is focused at infinity, the same as when our eyes focus on a target. The OEG projected a bright aiming dot that appeared focused on the same focal plane as the target. It was easier for veteran aimers/shooter to use and faster for novices to become proficient. Using the OEG was especially good in combat environments where ‘snap’, fast, accurate shooting could mean the difference between life and death. Rapid and near instantaneous target acquisition is one of the important advantages of the occluded eye gunsight. While ‘red dot’ sights have been extant since about 1900, the OEG was perhaps the first ‘red dot’ sight that brought its advantages in a usable, combat ready package for rifles (and other ‘long’ guns). To aim it, the shooter/aimer keeps both eyes open: one eye on the target. One on (in) the scope. These sights first operated by collecting ambient light and concentrating that light onto a fiber optic material which constituted the ‘red dot’. Later improvements were to employ tritium as a lighting source so that the sight could be used in low light environments or at night. In all cases, their chief advantage was that of single focal plane aiming.

### Technological Problems with Occluded Eye (OEG) Aiming Devices

OEG ‘red dot’ sights have constituted an important advance in aiming technology, and have also suffered from a variety of technological problems. Some of these problems are:
1) Not every person's brain merge images in the same way. Some people don't possess binocular vision, so the OEG sighting system is not as practical for them.
2) Fine accuracy, and accuracy at long range is hindered by the OEG sighting system, as only one eye sees the target, and one eye the sight.
3) If an aimer/shooter is unable to use one of their eyes as in a circumstance which requires them to aim and shoot from around cover, or with an eye injury or with something in their eye, the OEG is either impractical or introduces additional and unacceptable risk into a combat environment.
4) The sight itself may and does obscure a target, especially at longer ranges.
5) The integrated visual (psychological) assembly of the two images (the dot and the target) can degrade over prolonged use, depending on the user. In other words, over prolonged use, an aimer or shooter may experience the two visual fields moving with respect to each other.
6) Another problem with the OEG is that because of its size, volume, bulk and relative weight, it was impractical to be deployed on a sidearm or pistol.

### Technical and Technological Problems of Aiming Sights

### 1. Relative Size of Both Occluded and Non-Occluded ‘Red Dot’ Sights

Occluded ‘red dot’ sights are relatively large and obstruct more of the target and environment than the front sight of a notch and post (‘iron sight’) design. Any cause of obstruction in the environment that distracts the user of the aiming device generally constitutes a disadvantage for a shooter in combat. Occluded eye sights are also relatively heavy. The size and weight of these sights are characteristics that have prevented them from incorporation on pistols.

2. Need For Two Eyes and Binocular Vision with Occluded-Type Sights

Furthermore, when in either a combat scenario or in competition, a user often faces additional constraints vis a vis the use of binocular vision or the need to use two eyes. When using an occluded eye gunsight (OEG) it is necessary to use both eyes because OEG sights require the use of binocular vision. However, when practicing defensive techniques that demand limiting one's physical exposure to one or more adversaries, using both eyes is not always possible because the user must practice concealment and cover procedures. For example, there are scenarios when only one eye can be employed to view a target because the other eye is behind cover. Sometimes the environment itself obstructs a view using two eyes as in the case of vegetation or if a person is hiding behind a vehicle barricade that limit their ability to use both eyes. Moreover, the large size of an OEG itself reduces situational awareness, by severely occluding the field of vision of the aiming eye.

It is widely held in the art that a larger viewing window facilitates an easier aiming experience for a shooter/aimer. This prevalent design philosophy is illustrated in commercial products such as the Leupold Deltapoint Pro Red Dot (6 MOA, Pro FDE, Deltapoint Pro, Pro 6 MOA FDE, Pro with AR mount, Pro NV, Pro NV FDE) Sights, Leopold Carbine Optic, Leopold Freedom RDS Sights, Trijicon RMR Type 2 LED Adjustable Sights, Trijicon RMR Type 2 LED Reflex Sight, Trijicon RMR Dual Illuminated Reflex Sight, Trijicon RMR Dual Defense Kit (6 options), Trijicon SRO Red Dot Sights (SRO1-C, SRO2-C, and SRO3-C,) Trijicon MGRS Machine Gun Sight, Trijicon RMR cc Red Dot Sight, (CC06 & CC07), Trijicon MRO Red Dot Reflex Sight, Trijicon MRO Patrol Red Dot Sight, Trijicon MRO Green Dot Reflex Sight, Trijicon MRO HD Sights, and the Holosun Open Reflex Sights: (models & variants:) EPS, SCS, AEMS, 509, 508, 507, 407, 512, and 510) as well as Holosun Red Dot Sights (models & variants:) 403, 503, 515, 530, and 506. The Trijicon SRO, is even larger than the industry standard. Noblex Docter Sight G, Noblex Docter Sight III, and Noblex Docter Sight C. Notwithstanding this trend in the general art for larger windows, there are some commercial aiming products with generally small windows, notably the Leupold Deltapoint Micro sight (for Glock and Smith and Wesson) and the Noblex Glock MOS sight.

Though the observations for creating larger windows in rear sights constitutes a general trend in commercial sights, there are exceptions. The Leupold Deltapoint Micro and the Noblex-Docter Optics Glock MOS Integrated Red Dot sights are two examples where the concept of a rear sight smaller has been reduced to practice. Neither of these sights has approached the quantitative miniaturization embodied in these miniaturized aiming devices (MAD).

In the concealed carry and duty carry markets, the overall size of the sight can only be sized so large before it becomes cumbersome and difficult to carry and conceal. The market, as evidenced by the products noted (e.g., Trijicon, Leupold, Holosun), implement windows that are substantially similar in size.

In addition to these problems, there are additional problems in connection with non-occluded, ‘red dot’ sights:

3. Reticle Placement, Acquisition and Gross Placement using A ‘Red Dot’/Reticle

In at least one embodiment, one of the uses of these miniaturized aiming devices is as an aiming device on a firearm, specifically on a pistol. In this case, a user must orient his or her position to a fire-ready position from a non-fire-ready position. In at least one embodiment, a fire-ready position is when the user is holding the weapon, usually at arms length with the weapon ready to fire and in such a manner that they can instantly pull the trigger and are looking through the aiming sight at or towards a target. In at least one embodiment, a non-fire-ready position is any other position or orientation of the weapon such as when the weapon is secured in a holster or where the weapon is not deployed for aiming and firing. In at least one embodiment, getting into a fire-ready-orientation requires that user move a firearm into their visual field so as to aim the weapon, and this necessitates finding the red dot or reticle when such an aiming device is employed when using an optical or ‘red-dot’ type aiming device. Finding the red dot quickly requires training and in comparison with aiming a firearm with notch and post type sights, can take a longer time to learn until proficient. In at least one embodiment, one technical problem in aiming with some ‘red dot’ type/reticle-based aiming device is that it can and does take a moment or several moments to position and orient the aimed firearm, so as to get the red dot close to a target because the aimer or shooter does not receive visual feedback as to which way to adjust the aimed object. This problem is particularly noteworthy with tubeless designs such as the pistol non-occluded red dot reflex sites. Tubed sight designs such as those used on rifles do not suffer from this technical problem as much as on sights mounted on pistols.

In at least one embodiment, when using a red dot-reticle-based type aiming sight, there is an inherent, two step aiming process respectively: 1) gross and 2) fine visual indexing for target acquisition. Gross visual indexing means pointing the aiming device in the right direction and placing the red dot/reticle and a target together in the same sight picture. Fine visual indexing is the process of placing the red dot/reticle on the target. In an ideal situation, these two processes should occur intuitively, swiftly and seamlessly as when using notch and post type aiming sights.

### 4. Finding the ‘Red Dot’/Reticle

Accurate aiming of a pistol is desirable in competition or in target practice. However there are more critical scenarios than target practice or competition, where accurate and speedy aiming are literally a matter of life and death. In at least one embodiment, pistols are used in self defense by civilians, law enforcement and military personnel. The circumstances that give rise to combat are erratic, often unanticipated and unknown. Those using a weapon for self-defense are often at some kind of mental and/or physical disadvantage. The very nature of the circumstance is that a firearms user is often in a position where his or her “fight or flight” reflex kicks in. Whether under threat and stressed because they have been chased or are chasing after one or more assailants, have been injured physically, or are under fire. Some results of this stress are that the individual breathes rapidly and shallowly and has adrenaline pouring into his or her body. The flight-or-fight physiology causes trembling and shaking of limbs and degradation of fine motor control together with tunnel vision. Pupils typically dilate to allow more light, resulting in loss of near-vision, such as a firearm's sights. In these less-than-ideal circumstances, where an adversary may be endangering the life of the shooter, every moment (millisecond) counts. Each second that it takes to acquire or re-acquire a sight picture consists of 1,000 milliseconds where the shooter may either shoot or be shot by, one's adversary. On a gun range, or in one's backyard the extra time to ‘find the red dot’ might not be of any significant consequence. However, that extra time in combat is not a luxury any person can afford. In at least one embodiment, the term ‘aiming indicator’ or just ‘indicator’ refers to a red dot or other aiming indicator on an aiming device.

When using a single focal plane aiming device, especially with a reflex type sight on a sidearm, it takes a moment for the aimer/shooter to superimpose the red dot onto the target. It takes a second to ‘find the red dot’. The dot can be difficult to quickly locate for many reasons: the viewing angle of the dot, the height of the sight mount, and the type of coating on the glass all affect the process of visually acquiring the aiming point. So too does a shooter's biomechanical orientation to the sight. Often a change in grip angle or other technique is required, even among very advanced shooters. If one does not point the handgun properly, it can be difficult to quickly see the aiming dot (aiming indictor). Almost every situation where one is drawing and aiming a firearm is potentially lethal and every millisecond for target acquisition can mean the difference between life and death. Unlike iron sights, there is no obvious visual feedback to help locate the dot. This can be a critical limitation during physical combat, where proper presentation is not always possible. This phenomenon of ‘losing the dot’ or ‘finding/superimposing the dot’ can occur with ‘red dot’ sights after each shot is fired because when a bullet is fired, the recoil moves the gun a little bit. After each shot, there is a moment where the shooter/aimer must reposition the firearm and the sight to be able to aim again. This lag in the aiming process poses undesirable lethal risk to the shooter.

5. Problems with Transparent Windows: Susceptible to Fracture, Scratching or Shattering

The viewing window in non-occluded, ‘red-dot’/reticle type, window sight designs are susceptible to breaking because the transparent material, either glass or plastic, from which the windows are fashioned is fragile. There are instances where a broken or badly scratched window remains intact and impedes even basic aiming because these sights can prohibit or limit the effective use of notch and post sights as backup aiming devices.

6. Problems with Glass Windows: Window Can Fall Out Completely

The viewing window in any, ‘red-dot’ sight can just fall out of the housing prior to or during use. In the event there is no backup iron sights installed (a common practice) this renders the entire sight and aiming system useless.

7. Problems with Glass Windows: Window Tint Distorts Image

The tint used in a glass window in a non-occluded, ‘red-dot’/reticle type, window sight distorts the view in the aiming eye. Tinting is necessary in order to reflect the red dot back to the shooter's eye, while allowing the reflecting glass to be somewhat transparent. This tinting can change color perception, darken the field of view and as a result make it more difficult to accurately identify targets.

8. Problems with Glass Windows: Window Tint Inhibits Viewing of the Fixed Post ‘Iron Sight’

The tint used in a glass window in a non-occluded, ‘red-dot’/reticle type, window sight inhibits the user's ability to clearly see the front, fixed post sight. As a result of the tinting making anything beyond the window appear dimmer than objects not viewed through said window, a situation is created whereby it can sometimes be very difficult to align the iron sights, one or both of which sit beyond the glass viewing window.

9. Problems with Glass Windows: Broken or Fractured Window

if the window in non-occluded, ‘red-dot’ sight breaks or fractures, it may mean that the aimer/shooter is unable to use the back up iron sights as a backup to sight the aiming device.

### 10. Non-Occluded Red Dot Sights Limits Holster Options

When a non-occluded, red dot sights are installed on most firearms, it becomes impractical to fit a ‘pistol+sight’ combination into many holsters because many holsters are not equipped with a “optics cut” that allows for the insertion of a pistol with traditional (larger) pistol mounted optics.

In sum, It may be noticed that although non-occluded red-dot sights constitute improvements in the technology relative to occluded eye (OEG) aiming devices, non-occluded red dot sights also have meaningful technological and technical problems.

11. Learning Curve to Become Skilled and Adept using Non-OEG ‘Red Dot’ Sights

There is almost always a learning curve with non-OEG ‘red dot’ sights of the current art, particularly with respect to sidearms such as handguns. The viewing angle between the eye, and the sight with most existing dot sights is such that the shooter must learn a new way to point the gun to view the sights. The subjective experience of aiming feels substantially different from using traditional iron sights.

One problem of shooting with pistol mounted optics has been recognized by instructors in the firearms training community. Some of the most prestigious shooting schools now offer courses for “pistol mounted optics”, or courses for instructors who want to teach classes of students with pistol mounted optics. Some instructor course examples include are offered by Gunsite, Sig Academy and Sage Dynamics offer courses for firearm instructor and Sig Academy, Sentinel Defense and The Complete Combatant offer courses for students specifically on pistol mounted optics. This problem is so large that it is recognized by manufacturers. To that end, newer sights are becoming available where the dot sight is mounted lower, closer to being in line with rear sights.
(see: https://holosun.com/index/product/detail/id/209.html)

While this reduces the learning curve, there are still some inherent disadvantages inherent to currently available pistol mounted dot sights.

### 12. Pistols Require Permanent Alteration to Mount and Deploy Red Dot Sights

Almost all current conventional red dot sights require a special cut-out section of the slide for proper mounting on handguns. There is no good solution for carry or concealment to mount current dot sights absent the machining away of the top portion of pistol slide—“an optics cut”. Unfortunately, a very small percentage of handguns in existence currently have this type of optics cut. A disadvantage of the current art is that it is costly and somewhat risky to have a gunsmith machine one. Machining this ‘optics cut’ also permanently disfigures the pistol slide. Furthermore, not all handguns are designed to be able to have an optics cut.

In at least one embodiment, miniaturization of a single focal plane aiming sight and/or variants constitute an improvement to aiming devices. In at least one embodiment aiming device is referred to as a sight. In at least one embodiment, features of a miniaturized aiming device (MAD) include an aiming sight's structure, methods of manufacture, use and kitting of said sight.

In at least one embodiment. miniaturizing an occluded eye type aiming sight, advantageous features of both non-occluded and occluded red dot sights are incorporated into a new sight while at the same time removing some of the disadvantages from both.

In at least one embodiment, pertains to aiming devices such as firearms, handguns, rifles, shotguns, machine guns, grenade launchers, bows, crossbows, pulsed or phased weapons, lasers and laser-type weapons, artillery, mortars and anti-aircraft weapons. In at least one embodiment, a miniaturized aiming device is employed as an aiming device used by an airman or by an autonomous agent in an airplane cockpit to aim a weapon, missile, bomb or other munition at a target.

In at least one embodiment pertains to aimed devices or equipment such as telescopes, levels, sextants, parabolic microphones, camera or any other apparatus which are manually aimed.

These inventions are directed toward a miniaturized, collimated light-based single focal plane aiming sight where the word ‘miniaturized’ should be construed to breathe life and meaning into any invention that uses this word in a claim preamble. Sometimes during this specification, the abbreviation ‘MAD’ is invoked shorthand to refer to the inventions: ‘M’ for miniaturized, ‘A’ for ‘aiming’ and ‘D’ for device being a synonym for ‘sight’. Two expressions for the MAD invention include occluded and a non-occluded versions. Two additional expressions of the MAD invention include using 1) a ‘red dot’ (aiming point of collimated light) as an aiming signal, and 2) a holographic projection as an aiming signal and 3) a prismatic scope type setup, with or without an etched reticle. Red dot’ is used generically and does not necessarily refer to either the color ‘red’ or the shape ‘dot’. ‘The MAD possess aspects of an apparatus as well as aspects of methods, as explained below. Various embodiments, variants, derivatives and applications of the inventive concept are contemplated with any permutation of these inventive expressions. Another aspect of inventive concept relates to a kit of components or elements as well as a method for producing a kit of components or elements of these aiming sights. Still another aspect of the inventive concept includes the use of aiming sight inventions on or with an ‘aimed device’.

### 1. Miniaturization

For thousands—perhaps tens of thousands of years, men and women have been debating a question that is still controversial in some quarters: “Does size matter?”

By way of analogy, the relative size of certain products is considered by illustration. Given the choice of, a) as a passenger on an extended airplane ride would you rather sit in coach or in first class? b) in combat, which is most preferable—to shoot your enemy with a 0.22 caliber bullet or with a 0.45 or 0.50 caliber bullet? c) If you had to tow some personal belongings in a trailer to move from one place to another, which is most preferable—to tow them using a Volkswagen Beetle or using a Ford model 150, 250 or 350?

Sometimes size alone is a critical marker for the function that is a result of a change in size. A change in size alone can constitute a de facto improvement in technology because size alone can impart a qualitative change in function.

In these exemplary illustrations, the extra room in first class makes flying a better experience, getting shot with a 0.45 or 0.50 caliber bullet inflicts greater stopping power and/or lethality and the increased power delivered by a Ford 150 in comparison with the Volkswagen is safer and more efficient for towing. Isn't it true that a pair of tongs that one uses to cook spare ribs or hamburgers on one's barbecue is essentially the same macro apparatus as a pair of miniaturized surgical (blunt tip) forceps used by vascular surgeons? In this domain of aiming devices—the ‘size’ alone of this product influences the functionality of the apparatus to such a degree that size itself constitutes a critical structural element. The structure is essentially the same and functional mechanics of grabbing an object using a fulcrum grasping motion is the same. Yet, these are two apparatuses, performing an identical function to generate significantly different new results even though they both grasp. Likewise, miniaturization bestows upon these MAD aiming sights distinctive technical effects not present in the macro version. Miniaturization of the existing structural elements of these aiming devices confers improves functionality of aiming devices as explained below:

### 5. Single Focal Plane Aiming

Effective aiming of a projectile weapon such as a firearm generally requires the use of a sighting device. For the past 200 years or so, almost all firearms sights have been based on one unchanged system. A front sight post that is aligned with a rear sight “notch” or aperture. (“Notch and post sights”, also “Fixed post”, also ‘Iron sights’) This method of aiming is simple, but not always easy. To aim, the front sight post is visually centered (both vertically and horizontally) within the rear sigh notch. This visual “sight picture” is then aligned with the target to ensure an accurate hit. This method of aiming is so pervasive that some form of it is on almost every firearm in existence. Despite it's near universal acceptance, this method has several serious shortcomings. Chief among them is the need to focus at more than one focal length to achieve a proper sight picture. The eye must change its focus from the target, to the front sight, to the rear sight. Accomplishing this is not very difficult on a static range. But in situations of self-defense, combat and sometimes competition, this can become impossible.

The inventor has grasped that the chief advantage of existing telescopic and “red dot” type sights is single focal plane aiming as the ideal way to aim because there is no need for the shooter to focus on anything except the target, at which time the dot, being collimated, will appear over the target, at the same focal length, allowing the shooter to see his sights and target in sharp focus simultaneously.

The inventor has understood that the shortcomings, limitations and deficiencies of the conventional single focal plane aiming sights are overcome by miniaturizing the sight and sight elements. One inventive concept is to shrink a collimated light or holographic sight so that it small enough that just one eye can simultaneously see a target and also the sight's reticle, and that it's outside shape can be used as a front or rear iron sight. As a result of miniaturization, new and improved functions and functionalities emerge and accrue that are absent in sights of the current or prior art. Miniaturizing the red dot/reticle can reduce the critical lag time associated with ‘finding the red dot’/reticle. A miniaturized dot permits the user to aim just like they were using traditional ‘notch and post’ type sights, the sights that nearly all shooters learn with and use from the moment nearly everyone first handles a gun. The practice, experience and muscle memory thus carries over from notch and post to red dot/reticle aiming when the ‘red dot’/reticle takes the physical form of notch and post sights. This results in the elimination of the lag time associated with ‘finding the ‘red dot’/reticle. Another expanded functionality resulting from shrinking the sight is that it removes obstruction of the window and its housing, permitting a greater field of view so that a user may focus their attention on a greater field of view of the environment which can save the user's life because he or she is better able to assess and react to threats.

The invention of the miniaturized collimated aiming sight, in effect, constitutes the “Holy Grail” of aiming. Until the advent of these inventions, persons aiming devices such as handguns have had to choose between the 1) simplicity and ease of use of notch and post type sights which are simple to use and omnipresent, but do not deliver the same speed and accuracy potential as ‘red dot’/reticle sights, 2) Optical telescope or similarly tubed devices which are bulky and are not readily useful on a sidearm or 4) conventional ‘red dot’ reticle-based, reflex-type, non-occluded window sights, which provide great accuracy but generally suffer from the need for additional training and practice to gain proficiency in ‘finding the red dot/reticle’ quickly and reliably, as well as obstruction and lowered awareness of a battle space. A miniaturized reticle-based, windowed, non-occluded sight provides all of the advantages of these other sights and none of their disadvantages.

The inventor has had insight that the prevailing trend and conventional wisdom in the art has been to improve sights and in particular reflex and red dot sights by enlarging the sight window. The design theory underlying this conventional approach is that enlarging the reticle increased space to reflect at an angle where it will be caught the by the shooter's eye even before the shooter can align it properly with the target. Therefore, the sooner the shooter detects the reticle, the sooner the shooter can align the sight with the target. This is true, but there is a limit to how much the viewing angle can be improved, partly because there is practical limit to how much the viewing window can be enlarged. With current designs on the market, detecting the reticle quickly with smaller viewing windows is typically more difficult. So is tracking the dot during such activities as while the gun is in recoil or rapidly transitioning targets. This trend teaches away from the unconventional approach in sighting and aiming technology central to the MAD aiming device whose essential idea is to reduce the size of the housing and sight itself. For a user, it's comparatively easy to find the front sight post and know how to orient it to align with the rear notch. Instead of finding the dot in a window, the MAD aiming device (in one embodiment of the invention) operates when the shooter/aimer finds the dot inside the front “iron” sight, which is counterintuitive for how PHOSITAS and users have been thinking about dot sight design. By shrinking and miniaturizing the aiming device, the shooter/aimer receives the benefit of an illuminated dot combined with the comfort, concealability, full environmental awareness, and muscle memory that traditional fixed sights provide.

### 6. MAD Aiming Device as a Front Sight: Structural Concepts of Shape and Form

In at least one embodiment a combination of shrinking the MAD aiming sight, the shape of the housing and the corresponding arrangement of the internal technology components such as the power supply, light source and collimation element, as well as the wiring between these elements to mimic and emulate a front sight of a firearm. By doing so, in the event of a technology failure or damage that renders the illumination features of the sight to become inoperative, the sight can still function as a fixed post iron sight. Without the need to peer through dim, cracked or obstructed glass. This is achieved by either of two techniques: a) designing the housing itself of the MAD aiming device as a front or rear sight or b) designing the housing of MAD aiming device so that it can be positioned just proximal to standard iron sights. Although only three designs are shown for the MAD aiming device as ‘front sight’ are portrayed, any front sight shape is contemplated to be equivalent, and likewise for the MAD aiming device configuration that is designed to be installed proximal to an existing, standard iron sight. The inventor contemplates the use of occluded eye and/or reflex and/or holographic and/or prismatic technologies to be deployed in this manner. In at least one embodiment, miniaturization allows for single focal plane aiming. These designs and structures are further contemplated for any or all of the aimed devices cited in. At this moment in time, the occluded version is presently considered to be the preferred embodiment when deployed as a front sight.

### 7. Definitions

The word ‘miniaturized’ only has meaning when used in comparing and contrasting one object with another. ‘Miniature’ means ‘of a much smaller size than normal; very small’. When used with reference to these inventions, ‘miniaturized’ is compared and contrasted to ‘red dot’ aiming sights in the prior art with particular reference to both occluded and non-occluded aiming sights. Fixed post iron sights are not included in the comparison-contrast reference. “Miniaturization” of the instant inventions occurs when the following conditions are fulfilled:
a) The sight is small enough so that when used, it is possible to see the dot and the desired impact area on the target simultaneously with one eye.
b) The sight is held at an angle substantially like what one would use with standard iron sights.
c) The sight body does not obscure so much of the target as to become a tactical or practical disadvantage, allowing for increased situational awareness.
d) All components are small enough that they may be housed so that nothing hangs over any edges of the aiming device.

In at least one embodiment, a miniaturized aiming device is miniature with respect to both occluded and non-occluded red dot sights in at least four ways. 1) The MAD is smaller when each of the 3D dimensions of height, width and depth are summed. 2) The MAD is smaller when evaluated as the largest 2D cross section versus prior art when the cross section is taken normal to the longitudinal axis of the aimed device. 3) The MAD has a smaller mass in comparison and contrast to the prior art. 4) The MAD consumes less power in comparison and contrast to the prior art in it's occluded embodiment. The term miniature as used refers to these metrics taken as a whole. One may appreciate that there is a causal nexus between the miniaturization of the sight's structural elements and the features and characteristics that bestow advantage upon the MAD invention. The term ‘miniature’ should also be understood to refer to like embodiments of the MAD invention in comparison and in contrast to like prior art. For example, an embodiment for a MAD rifle sight is miniature with respect to prior art for a rifle sight. Likewise an embodiment for a MAD pistol sight is miniature as compared and contrasted to prior art pistol sights.

OEG means ‘occluded eye gunsight’ and refers to any occluded eye sight whether or not it is used on firearm. ‘Occluded’ is used in its usual and customary manner when directed to aiming sight technology which is consonant with the definition given by Merriam-Webster's definition #1 “to close or block off”, that is to ‘obstruct’. This means that one may peer into the proximal end of an OEG tube housing and be unable to see the environment through the other end of the tube/housing because the light is obstructed from entering the distal side of the tube by an obstructing element such as a lens cover or a light source structure. Collimated means to make the light rays substantially parallel. Collimated light refers to the usual and customary definition in physics and technology of optics whereby light is processed to make the collimated beam of light or other electromagnetic radiation have parallel rays. As a result of collimation in an aiming device, the light visible to the shooter-the reticle—can be caused to travel in a path substantially parallel to the path of the projectile. Collimation is a technique used in aiming device technology. The light that passes through a collimator is called collimated light and a sighting device that uses this collimated light to produce a dot or a red dot is called a ‘collimated light-based’ sight. “Dot” refers to the visual marker produced by the collimated aiming sight and is a term of art used colloquially in the shooting community, however the visual marker is not necessarily a dot and is not necessarily ‘red’. A so-called red dot sight could be in the shape of any recognized symbol such as a triangle, rectangle, crosshairs or other symbol or symbols and could be any of a variety colors. Often times, aimers/shooters refer to a ‘red dot’ and mean ‘the combination of the luminous ‘dot’ together the markings that appear in the sight also, though technically the optical markings are the reticle. Red dot is the most common visual marker and so, these sights have come to be known as ‘red dot’. Red dot sights encompass all sights that use a ‘red dot’ (or other visual marker, regardless of color or shape) as an illuminated image projected onto a visual field and includes prism sights, holographic sights and reflex sights. A ‘reflex sight’ or ‘reflector sight’ an optical sight that allows the user to look through a partially reflecting glass element and see an illuminated projection of an aiming point or some other image superimposed on the field of view. A reflex sight ‘uses a refractive or reflective optical system to generate a collimated beam of light that is projected toward the user to create an illuminated reticle. The resulting light (plane wave) seen by the user appears as a small, approximately circular disc of light that is focused at infinity. In a standard open reflex sight this illuminated reticle is projected such that it is superimposed over the field of view observed through the sight. This allows the user to see the target field through the sight as well as the illuminated reticle (e.g. an illuminated red dot) in one eye simultaneously. This gives the user a theoretically parallax-free image of the reticle, superimposed over the field of view through the sight’. In at least one embodiment, non-occluded refers to an aiming device or sight where when one peers through one end of the sight, one can see the environment through the sight at the other end. In other words, the vision of the one looking through the sight is not obstructed. To ‘aim’ or ‘aiming’ means point or direct an apparatus (an ‘aimed device’) at a target. An ‘aimed device’ means the apparatus that one is aiming—any apparatus and including the exemplary apparatus cited, but not limited to, those cited above. In at least one embodiment, ‘Aiming Sight’ means a sight for aiming. ‘Aiming device’ is used generically to refer to an ‘aiming sight’. ‘Aiming device’ and ‘Aiming sight’ are used synonymously. A ‘Single focal plane sight’ means that a shooter or aimer need only view one single focal plane which includes the sight and the target. This is advantageous and beneficial to a shooter who and become distracted by or pre-occupied with doing the mental and physical work required to align object in different focal planes. Occluded eye red dot sights (OEG) are single focal plane as are non-occluded sights. In contrast, fixed-post ‘iron’ sights require a shooter/aimer to focus on a target (plane ‘a’), a front sight (plane ‘b’) and a rear sight (plane ‘c’) or 3 planes—a multi or multiple focal plane aiming device. A ‘holographic aiming’ sight is an aiming sight that projects a hologram onto and superimposed with a target. ‘Power Supply’ for these inventions means a) non-rechargeable and rechargeable batteries, b) fuels cells, c) light gathering fiber optics or other light gathering technology, d) any combination of these or e) future technologies. ‘Light Source’ for these inventions means: a) radio-luminescent sources such as tritium, b) fiber optics or other light-gathering technology, c) all type of LEDs including standard LEDs, mini-LEDs, and micro-LEDs d) bioluminescence e) ambient light, and f) any combination of those or f) future technologies. An ‘aimed device's central axis’ is the axis of a barrel of a firearm such a rifle, pistol, or shotgun. The aimed device central axis is the axis of main lens(es) a telescope, camera lens or other optical instruments. A ‘reticle’ is a pattern of fine lines or markings built into the eyepiece of an optical device, in this case, an aiming device or sight to provide measurement references during the aiming process. This may be as simple as a “dot” or a more complex series of indicator marks and symbols. ‘Refractive’ Is a phenomenon of light, (or other waves) being deflected when passing obliquely through the interface between one medium and another or through a medium of varying density. ‘Reflection’ occurs when light returns to a surface. In at least one embodiment, a collimation element includes an element that projects a visual cue to the aimer that correspond substantially with where the aimed device is pointed.

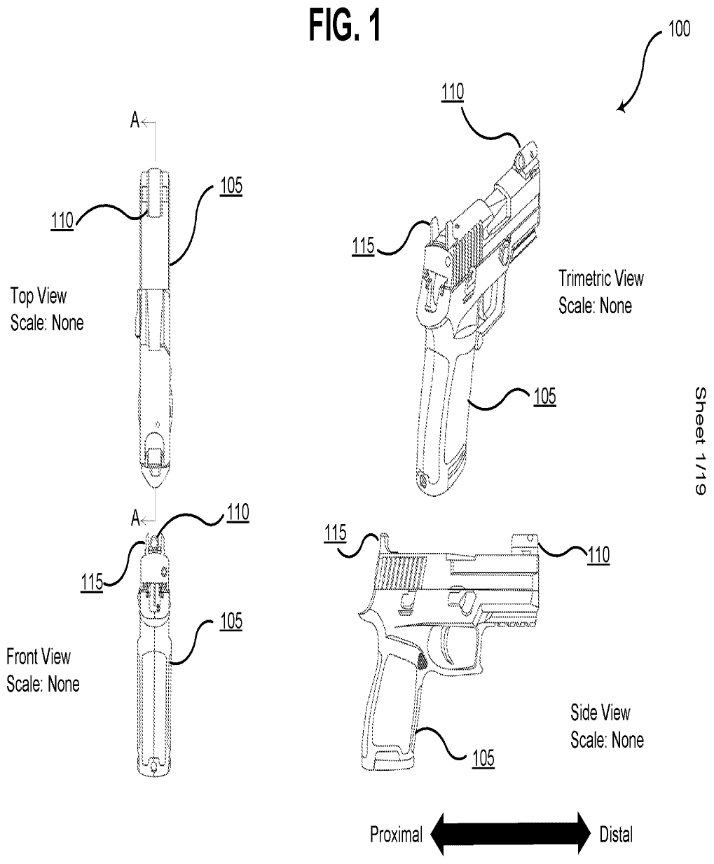

In at least on embodiment, FIG. 1 shows environment 100, a miniaturized aiming device (MAD) configured on a pistol. This figure shows a top view, a front view, a side view and a trimetric view. The top view shows a cross section A-A. In at least one embodiment, a configuration for the MAD is when it is mounted on a pistol 105. In at least one embodiment, the MAD is mounted on an aimed device as a front sight 110. In at least one embodiment, a MAD aiming assist rear notch iron sight 115 is mounted as a rear sight.

In at least one embodiment, a MAD front sight is further illustrated in FIG. 2 which shows environment 200, a MAD configured on a sidearm. In at least one embodiment, FIG. 2A shows a trimetric view of a MAD front sight and side arm. In at least one embodiment, FIG. 2A corresponds to FIG. 1 trimetric view. In at least one embodiment, FIG. 2B corresponds to FIG. 2A view A-A and shows a MAD 210 configured on a sidearm 205. In at least one embodiment, rear iron sight 215 corresponds with rear iron sight 115. In at least one embodiment, side arm 205 corresponds with side arm 105. In at least one embodiment, MAD front sight 210 corresponds with MAD front sight 110.

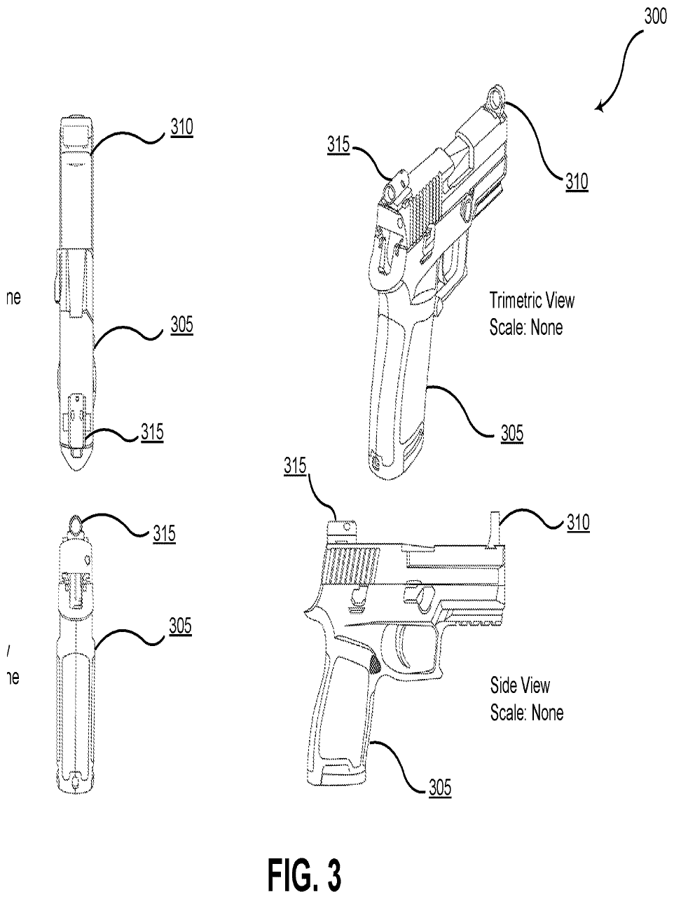

In at least on embodiment, FIG. 3 shows a miniaturized aiming device (MAD) configured on a pistol. This figure shows a top view, a front view, a side view and a trimetric view. In at least one embodiment, a configuration for the MAD is when it is mounted on a pistol 305. In at least one embodiment, the MAD is mounted on an aimed device as a rear sight 315. In at least one embodiment, a MAD aiming assist ‘ghost ring’ iron sight 310 is mounted as a front sight.

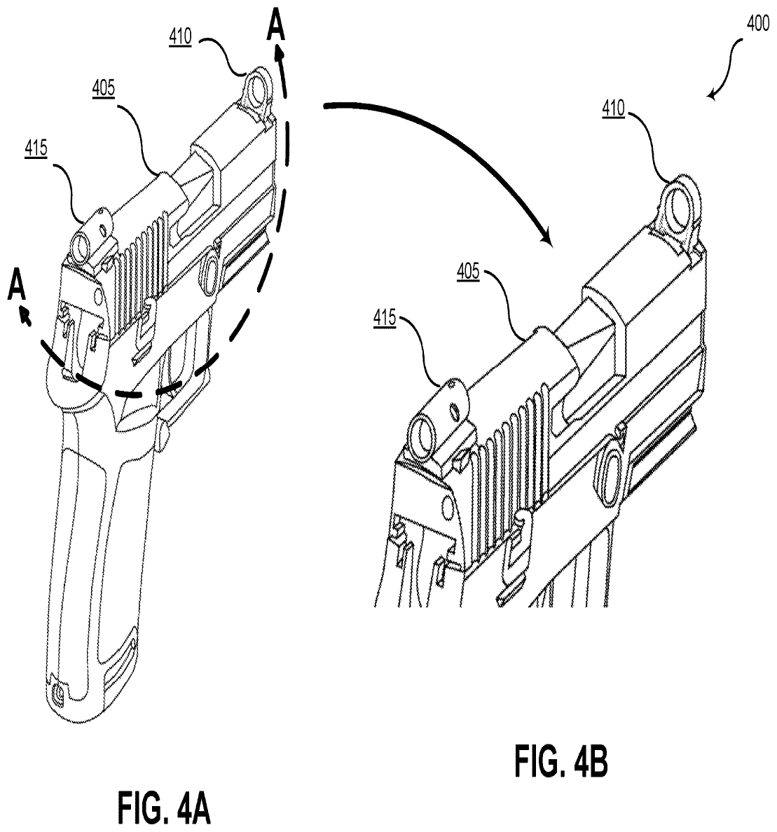

In at least one embodiment, a MAD front sight is further illustrated, as shown in FIG. 4. In at least one embodiment, FIG. 4 shows 400 a MAD configured on a sidearm. In at least one embodiment, FIG. 4A is a trimetric view of a MAD front rear and a sidearm. In at least one embodiment, FIG. 4A corresponds to FIG. 3 trimetric view. In at least one embodiment, FIG. 4B corresponds to FIG. 4A view A-A and shows a MAD 415 configured on a sidearm 405. In at least one embodiment, front iron sight 410 corresponds with front iron sight 310. In at least one embodiment, side arm 405 corresponds with side arm 305. In at least one embodiment, MAD rear sight 415 corresponds with MAD rear sight 315.

In at least one embodiment, it is noted that a MAD may be configured on an aimed device in the front, rear or elsewhere on an aimed device and the place where a MAD is mounted is not limited by an specific embodiment portrayed herein.

In at least one embodiment, it is noted that a MAD shape is not limited to any of the particular shapes portrayed by a specific embodiment portrayed herein. It is contemplated that a MAD shape may be designed, manufactured or deployed such that it is configured in different shapes. FIGS. 2, 5 and 6 illustrate some, but not every, shapes that a MAD may take.

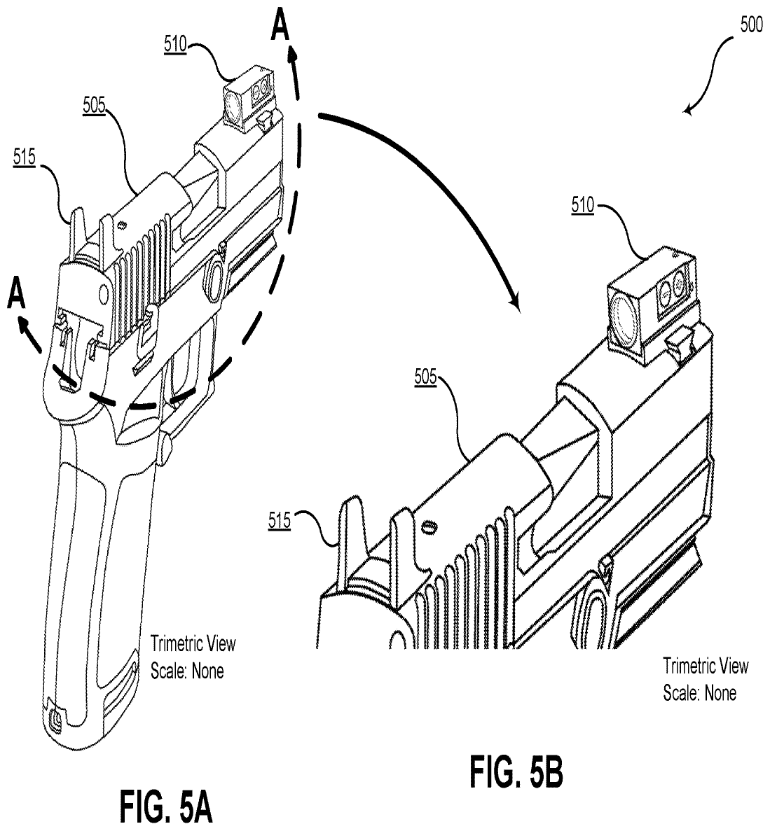

In at least one embodiment, FIG. 5 shows 500 a MAD configured on a sidearm. FIG. 5A shows a MAD 510 configured on a side arm 505 as a front sight. In at least one embodiment, rear iron sight 515 is mounted on said sidearm 505. In at least one embodiment, FIG. 5B illustrates an enlarged view of view A-A. In at least one embodiment, MAD front sight 510 is shown with a rectangular housing cross section.

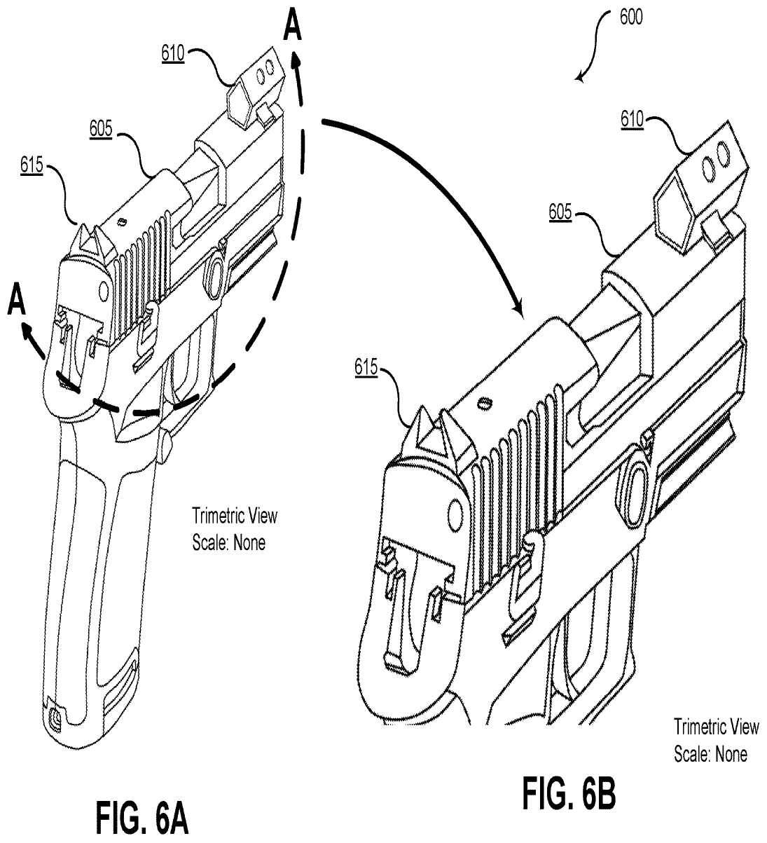

In at least one embodiment, FIG. 6 shows environment 600, and MAD configured on a sidearm. In at least one embodiment, FIG. 6A shows a MAD 610 configured on a side arm 605 as a front sight. In at least one embodiment, rear iron sight 615 is mounted on said sidearm 605. In at least one embodiment, FIG. 6B illustrates an enlarged view of view A-A. In at least one embodiment, MAD front sight 610 is shown with a pentagonal housing cross section.

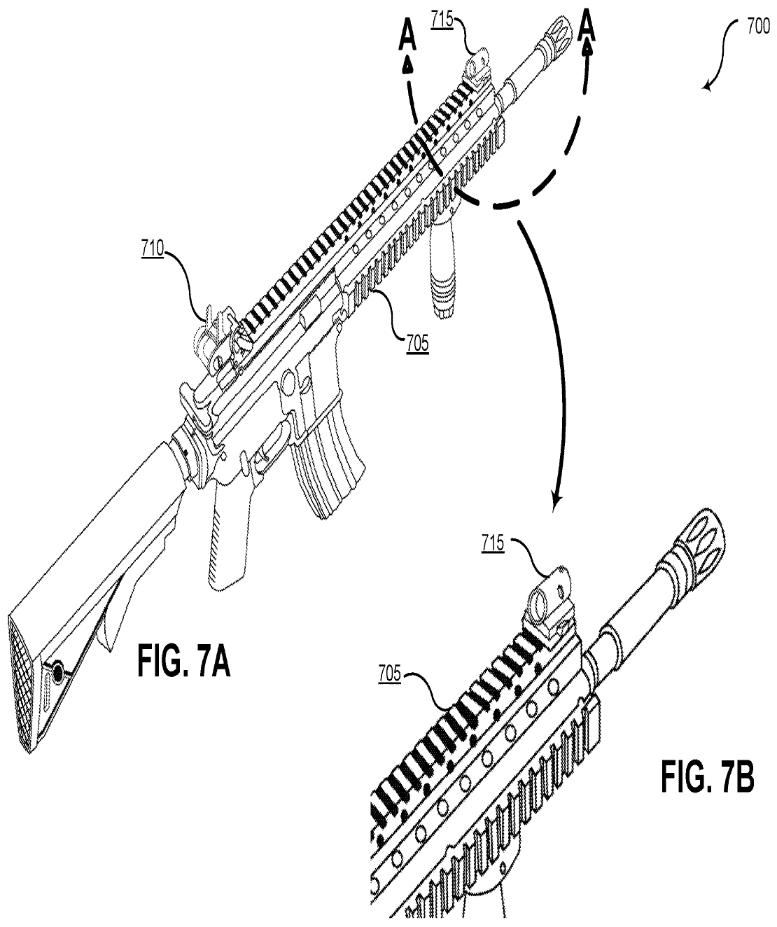

In at least one embodiment, FIG. 7 shows environment 700, and MAD configured on a long gun. In at least one embodiment a long gun can be rifle. In at least one embodiment, a long gun can be a shotgun. In at least one embodiment a long gun can be an artillery munition that is typically carried, held and/or aimed with two or more arms. In at least one embodiment, FIG. 7A shows a MAD 715 configured on a long gun 705 as a front sight. In at least one embodiment, rear iron sight 710 is mounted on said long gun 705. In at least one embodiment, FIG. 7B illustrates an enlarged view of view A-A.

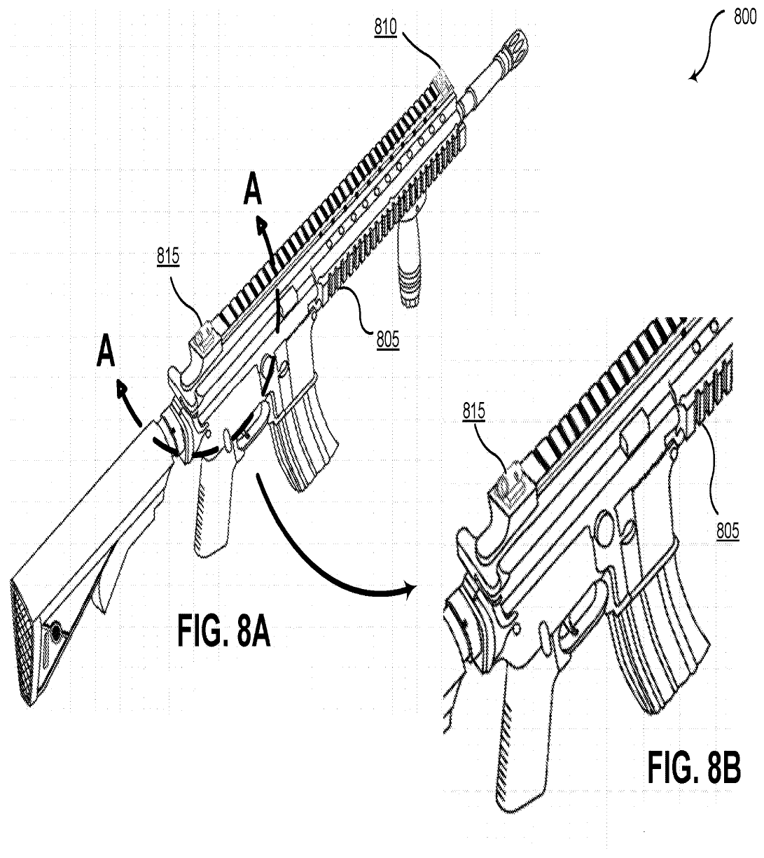

In at least one embodiment, FIG. 8 shows environment 800, a MAD configured on a long gun. In at least one embodiment a long gun can be rifle. In at least one embodiment, a long gun can be a shotgun. In at least one embodiment a long gun can be an artillery munition that is typically carried, held and/or aimed with two or more arms. In at least one embodiment, FIG. 8A shows a MAD 815 configured on a long gun 805 as a rear sight. In at least one embodiment, front iron sight 810 is mounted on said long gun 805. In at least one embodiment, FIG. 8B illustrates an enlarged view of view A-A.

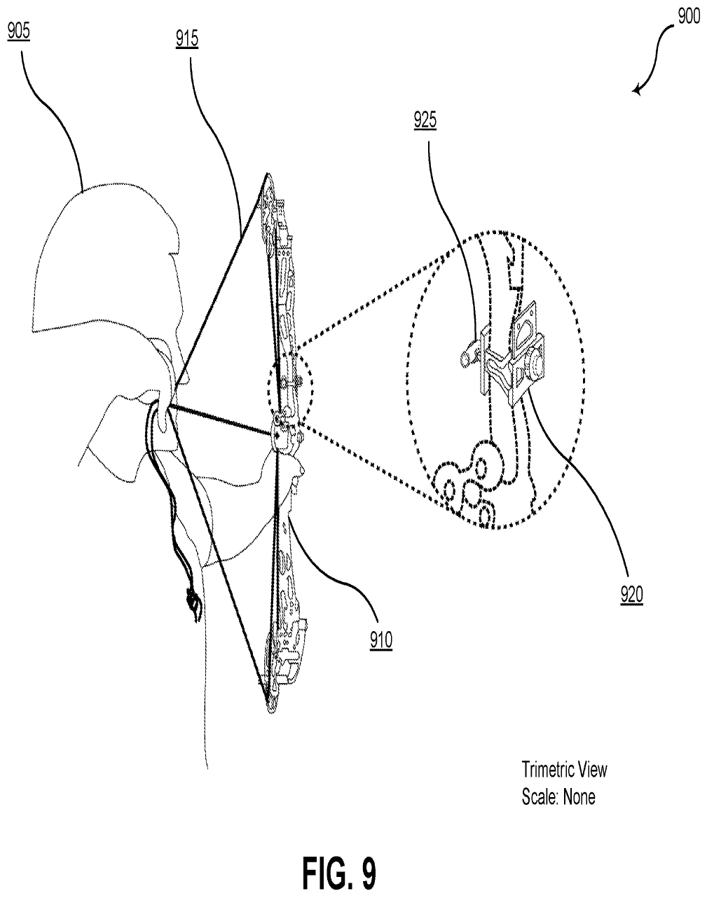

In at least one embodiment, FIG. 9 shows environment 900, and MAD configured on a bow and arrow. In at least one embodiment a bow 910+915 and arrow and be a long bow (and arrow). In at least one embodiment, a bow can be a cross bow. In at least one embodiment, the MAD can be mounted on a different kind of armament or other aimed device. In at least one embodiment, FIG. 9 shows a MAD 925 configured on the bow 910. In at least one embodiment, a MAD 925 is mounted on a box 910 using a mounting apparatus 920.

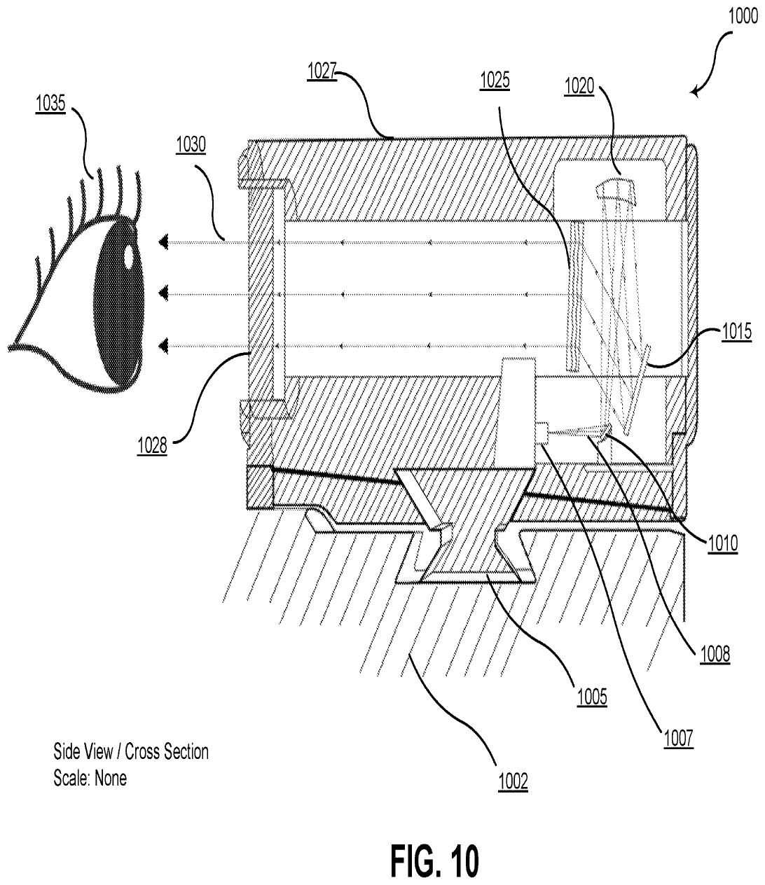

In at least one embodiment, FIG. 10 shows environment 1000, a cross section of a MAD configured on an aiming device where the cross section is taken from A-A from FIG. 1 and rotated clockwise for a 90 degrees view. In at least one embodiment, 1000 shows a holographic-type miniaturized aiming device. In at least one embodiment a MAD is configured in or on a aimed device 1002. In at least one embodiment the means for configuring the MAD to an aimed device is through 1005 a dovetail with a male and female. In at least one embodiment, a MAD housing 1027 provides a structure to house the MAD aiming device elements. In at least one embodiment, a light source 1007 provides light, said light shown in FIG. 10 as light rays 1008. In at least one embodiment, these light rays emanate from the light source. In at least one embodiment, the light source 1007 is a laser diode. In at least one embodiment, the light rays shine on a mirror 1010 and are transmitted to collimating reflector 1020. In at least one embodiment, said light rays are transmitted to holographic grating 1015. In at least one embodiment, said light rays form a holographic image at reticle 1025. In at least one embodiment, said holographic image is transmitted as 1030 in the direction of a viewer/aimer 1035, represented in one embodiment as an eye where said viewer/aimer sees said hologram. In at least on embodiment, protective viewing window 1028 is planar.

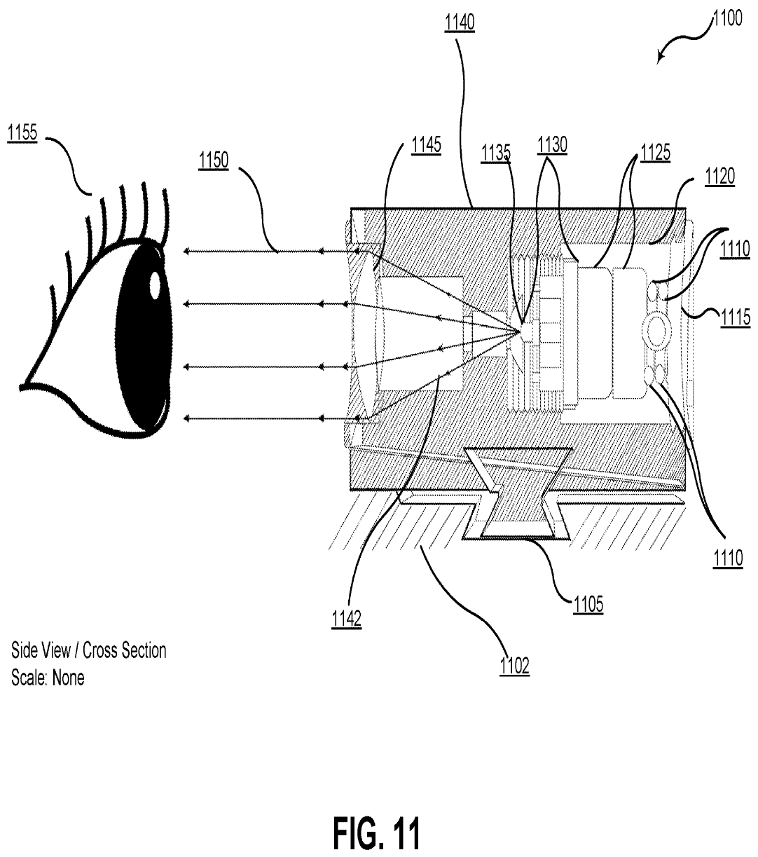

In at least one embodiment, FIG. 11 shows environment 1100, a cross section of a MAD configured on an aiming device where the cross section is taken from A-A from FIG. 1 and rotated clockwise for a 90 degrees view. In at least one embodiment, 1100 shows an occluded-type miniaturized aiming device. In at least one embodiment a miniaturized occluded aiming sight (MAD) operates similarly to a macro occluded aiming sight such as the Singlepoint/Armson sights. In at least one embodiment, a MAD refractive occluded (occluded), is directed to a much smaller volume, cross section and mass. In at least one embodiment, a MAD occluded sight is scaled and sized so that it can be installed proximally, on the top of a firearm such as a handgun. (From the perspective of a shooter/aimer, proximal and distal are used in their customary usages: proximal—‘toward the shooter/aimer’, distal—‘away from the shooter/aimer’.)

In at least one embodiment a MAD is configured in or on a aimed device 1102. In at least one embodiment the means for configuring the MAD to an aimed device is through 1105 a dovetail with a male and female. In at least one embodiment, a MAD housing 1140 provides a structure to house the MAD aiming device elements. In at least one embodiment, a miniaturized aiming device power cavity contains the power supply elements for the MAD. In at least one embodiment, this occluded MAD uses batteries 1125 to furnish power to said MAD. In at least one embodiment, said battery is held snugly by battery contacts 1110. In at least one embodiment battery cover 1115 encloses said battery. In at least one embodiment said battery cover 1115 is attached by means of threads that screw into power cavity 1120. In at least one embodiment, a light source assembly 1130 receives power from battery 1125. In at least one embodiment, a light source 1135 generates light. In at least one embodiment light source 1135 is a light emitting diode (LED). In at least one embodiment, light rays 1142 are emitted from the light source 1135 in the direction of a viewer/aimer 1155. In at least one embodiment, said light rays 1142 pass through a collimating lens 1145 and traverse as collimated light 1150 toward a viewer/aimer 1155 who sees an image.

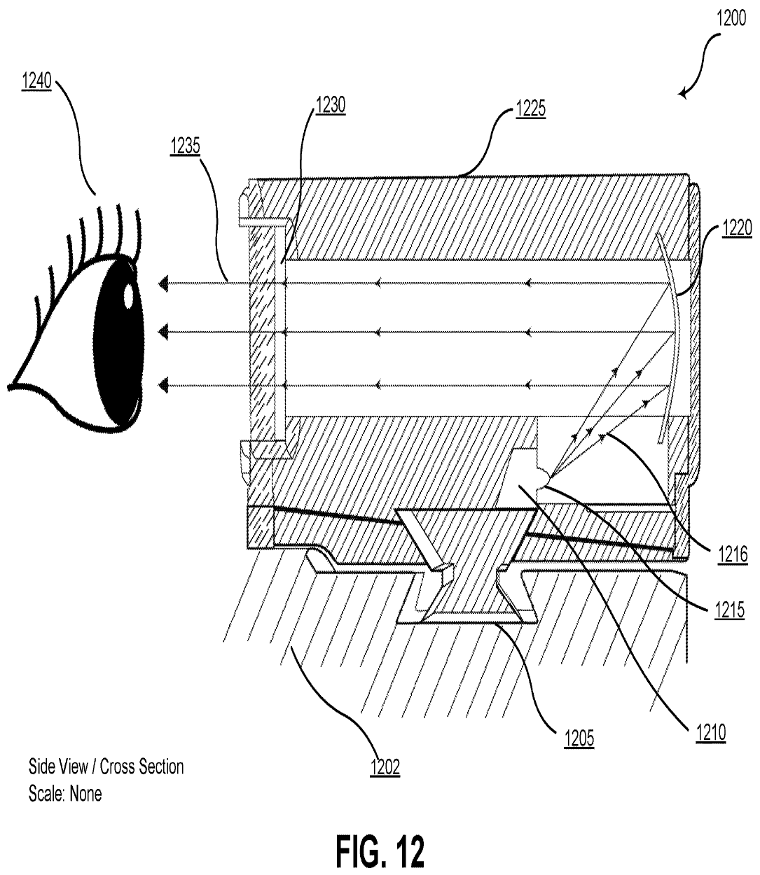

In at least one embodiment, FIG. 12 shows environment 1200, a cross section of a MAD configured on an aiming device where the cross section is taken from A-A from FIG. 1 and rotated 90 degrees clockwise. In at least one embodiment, 1100 shows a reflex-type miniaturized aiming device. In at least on embodiment, a MAD sight is characterized by miniaturizing non-occluded reflex sights. The structural elements for this sight include red dot sights. In at least one embodiment, structural elements and assembly in miniaturized inventions function similarly to their larger, macro cousins In at least one embodiment, this sight is non-occluded, meaning that the shooter/aimer can see through the sight.

In at least one embodiment, an illuminated dot is created by gathering light from a fiber optic, by tritium luminescence or by an LED or laser diode. In at least one embodiment, In this example, a dot is imagined and created by an LED. In at least one embodiment, said sight operates by means of reflective optical system to generate a collimated beam of light that is projected toward the user to create an illuminated reticle. In at least one embodiment, a resulting reticle seen by a user appears as a small, approximately circular disc of light that is focused at infinity. In at least one embodiment, a standard open reflex sight this illuminated reticle is projected such that it is superimposed over the field of view observed through the sight. In at least one embodiment, this allows a user to see the target field through the sight as well as the illuminated reticle (e.g. an illuminated red dot) in one eye simultaneously. In at least one embodiment, this gives the user a theoretically parallax-free image of the reticle, superimposed over the field of view through the sight.

In at least one embodiment a MAD is configured in or on a aimed device 1202. In at least one embodiment the means for configuring the MAD to an aimed device is through 1205 a dovetail with a male and female. In at least one embodiment, a MAD housing 1225 provides a structure to house the MAD aiming device elements. In at least one embodiment a miniaturized aiming device light source 1210 emits light. In at least one embodiment said light source 1210 produces light rays 1216 which shine onto a collimating mirror 1220. In at least one embodiment said collimating mirror 1220 is curved. In at least one embodiment, said collimating mirror 1220 is semi-transparent. In at least one embodiment, a semi-transparent collimated mirror is implemented for a non-occluded type miniature aiming device. In at least one embodiment, a collimated mirror 1220 is opaque. In at least one embodiment, an opaque collimated mirror 1220 is implemented for an occluded-type miniature aiming device. In at least one embodiment, said light rays 1216 are projected from said collimating mirror in the direction of a viewer/aimer 1240. In at least one embodiment, said light rays 1235 pass through a protective window 1230 and pass toward a viewer/aimer 1155 who sees an image.

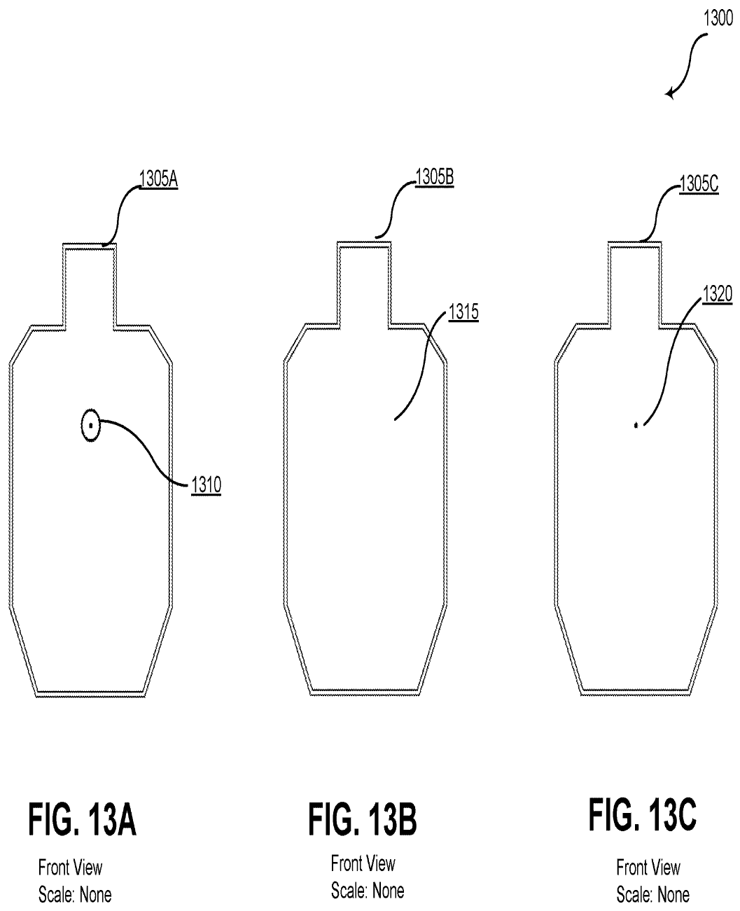

In at least one embodiment, FIG. 13 shows environment 1300, a concept illustration showing how a brain interprets visual signals received from a user of a non-occluded miniaturized aiming device. In at least one embodiment, FIG. 13A shows 1305A a standard United States Practical Shooting Association (USPSA) target. In at least one embodiment, said target is shown as 1305B in FIG. 13B and as 1305C in FIG. 13C. In at least on embodiment, an aimer or viewer looking through a non-occluded miniaturized aiming device will see an aiming or targeting image such as a red dot 1310 along with the sight housing with one eye. In at least one embodiment said one eye is the left eye. In at least one embodiment, said aimer or viewer will see a target in the other eye. In at least one embodiment the other eye is the right eye. In at least one embodiment, an aimer/viewer's brain will merge image 13A and 13B together so that said aimer/viewer will see the composite image shown as 13C with a red dot 1320 on a target 1305C.

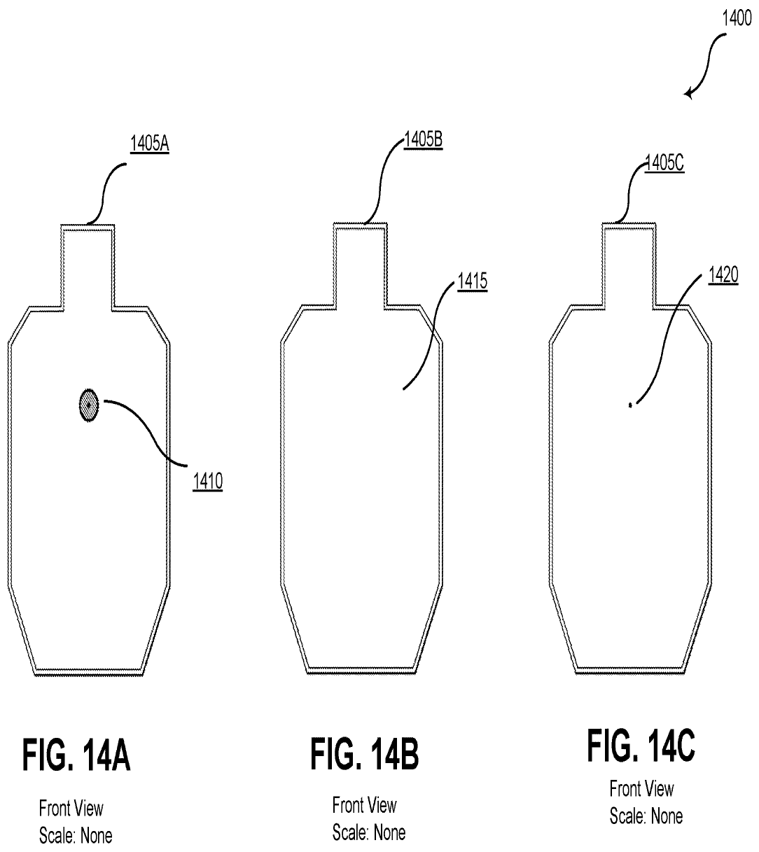

In at least one embodiment, FIG. 14 shows environment 1400, a concept illustration showing how a brain interprets visual signals received from a user of an occluded miniaturized aiming device. In at least one embodiment, FIG. 14A shows 1305A a standard United States Practical Shooting Association (USPSA) target. In at least one embodiment, said target is shown as 1305B in FIG. 14B and as 1405C in FIG. 14C. In at least on embodiment, an aimer or viewer looking through a occluded miniaturized aiming device will see an aiming or targeting image such as a red dot 1410 along with occluded sight housing with one eye. In at least one embodiment said one eye is the left eye. In at least one embodiment, said aimer or viewer will see a target in the other eye. In at least one embodiment the other eye is the right eye. In at least one embodiment, an aimer/viewer's brain will merge image 14A and 14B together so that said aimer/viewer will see the composite image shown as 14C with a red dot 1420 on a target 1405C. The reader may notice that said occluded MAD 1410 is shown with a darker area inside the circle to illustrate that said sight is occluded.

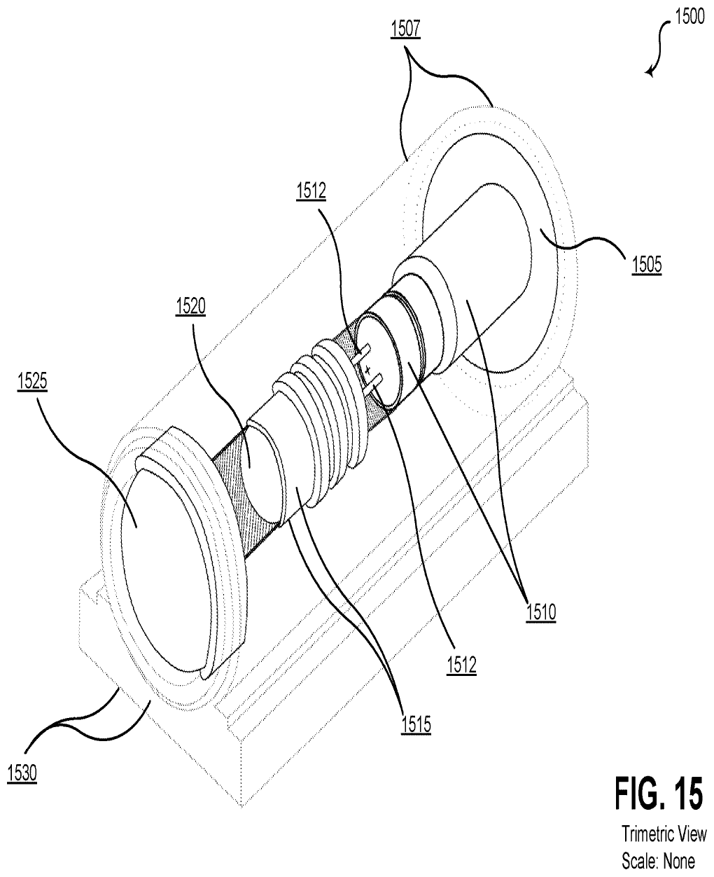

In at least one embodiment, FIG. 15 shows environment 1500, a miniaturized aiming device shown in a trimetric view. In at least one embodiment said MAD is visualized with a housing 1507, as see-through. In at least one embodiment, 1505 shows a cover. In at least one embodiment, cover 1505 is a battery cover. In at least one embodiment, a power housing 1510 is shown. In at least one embodiment said power housing 1510 is a housing for a battery. In at least one embodiment, a light source is shown as 1520. In at least one embodiment, said light source is an LED. In at least one embodiment, said light source 1520 is part of said light source assembly 1515. In at least one embodiment, light is generated from a light source 1520 and light rays (not shown) pass through a collimating lens 1525. In at least one embodiment, the MAD is supported on a base 1530. In at least one embodiment, said base is a structural portion of an aimed device. In at least one embodiment, the base may contain the ability to “zero” the sight left and right and/or up and down. In at least one other embodiment, these adjustments may be located inside the sight itself.

Miniaturization can only be understood when one a first object is compared or contrasted with a second object. A water molecule is miniature compared to a raindrop, yet quite large compared to a hydrogen atom.

Three features that define miniaturization in this this MAD are: function, context, and physical dimensions. Miniaturization of an aiming device is defined with respect to any combination of these.

### Miniaturization Function

In at least one embodiment, functional capabilities may change with miniaturization, as is the case with the MAD. In at least one embodiment, said function of a MAD may be characterized by the ability for the device to be used as a complete front sight or rear sight on a handgun, rifle, or shotgun. In at least one embodiment, even absent the single focal plane aiming functionality of the device, it is still small enough to function in the iron sight method when aligned with its counterpart sight. (i.e., a front sight MAD is small enough that it may be aimed via the single focal plane method, OR via aligning with a compatible rear sight such that, when both aligned, one may aim accurately.)

In at least one embodiment, the entire visual area that the aimer views to aim the MAD is small enough to be effectively used as either a rear or front sight, in conjunction with its counterpart.

In at least one embodiment, a front sight handgun mounted MAD is fit inside a holster.

### Miniaturization Function

In at least one embodiment, miniaturization is context dependent: a miniaturized rifle aiming device may reasonably need to be larger than a miniaturized handgun aiming device. In at least one embodiment, a rifle mounted MAD might naturally be physically larger than a handgun mounted MAD. In at least one embodiment, a full size handgun mounted MAD may be larger than a compact handgun mounted MAD. In at least one embodiment, context dictates both the need and the limits of miniaturization.

### Miniaturization—Physical Dimensions

In at least one embodiment and with the context in mind, approximate upper size limit guidelines for miniaturization for handguns and long guns are presented. In at least one embodiment, one dimension is the face of the sight that the aimer looks to for aiming. In at least one embodiment, length is dictated by the available real estate offered by the aiming device mounting point. In at least one embodiment, miniaturization is defined by adding height and width together to come up with a single number that may be used in comparing the MAD against other aiming devices. In at least one embodiment, the following metrics define ‘miniature’ with respect to a miniaturized aiming device:
Handgun Front Sight: Maximum Height: 0.650″. Maximum Width: 0.650″.
Handgun Rear Sight: Maximum Height: 0.750″. Maximum Width: 0.750″.
Long Gun Front Sight: Maximum Height: 0.750″. Maximum Width: 0.750″
Long Gun Rear Sight: Maximum Height: 0.850″. Maximum Width: 0.850″

Evaluation of the size and weight of commercially available rear sight aiming devices for rifles and pistols compared with the MAD aiming devices is considered.

### Rear Sight Rifle Optic—Miniaturized Aiming Device Comparison & Contrast

The average length of the Aimpoint H-2 Micro, T-2 Micro, Duty RDS, Trijicon MRO, Vortex Crossfire 2, Sparc AR, Holosun HE50C, HS403B, Sig Romeo 5, EoTech HWS EXPS3 is 2.81″, the average width for these same models is 1.55″, the average height, 1.568″ and the average weight, 5.49 ounces. In contrast, the instant invention—MAD sight is substantially smaller. Early designs are approximately 1.3″ in length, 0.7″ in width, 0.7″ in height, and 0.6 ounces. In sum, the instant invention—MAD sight is about 45% the average dimension of 10 aiming sights currently on the market, and 11% of the weight of those same sights. In at least on embodiment, the MAD is, on average, 55% smaller and 89% lighter than the current sights.

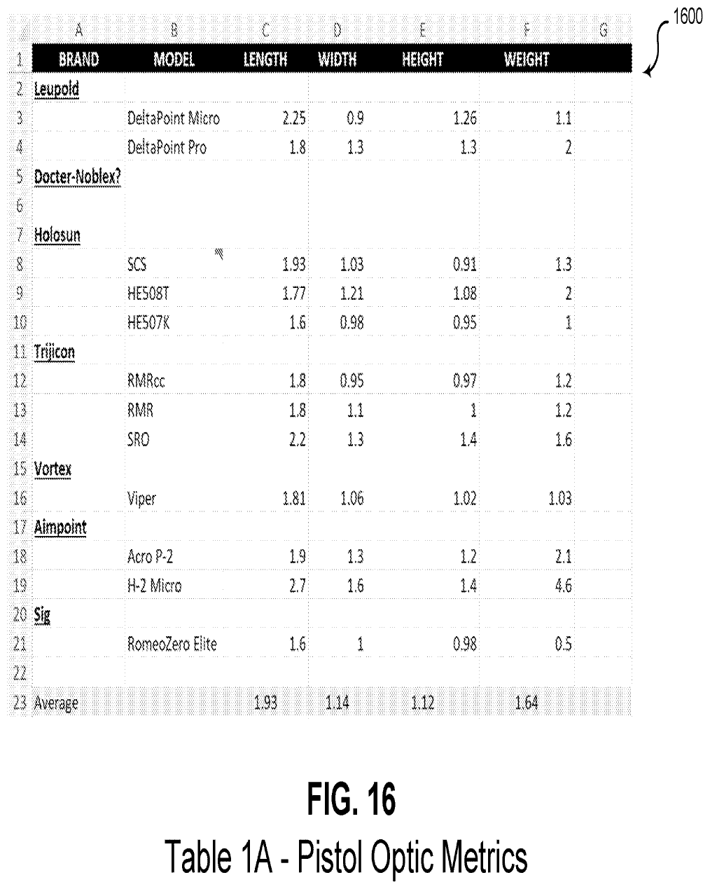

FIG. 16 shows TABLE 1A—Pistol Optic Metrics.

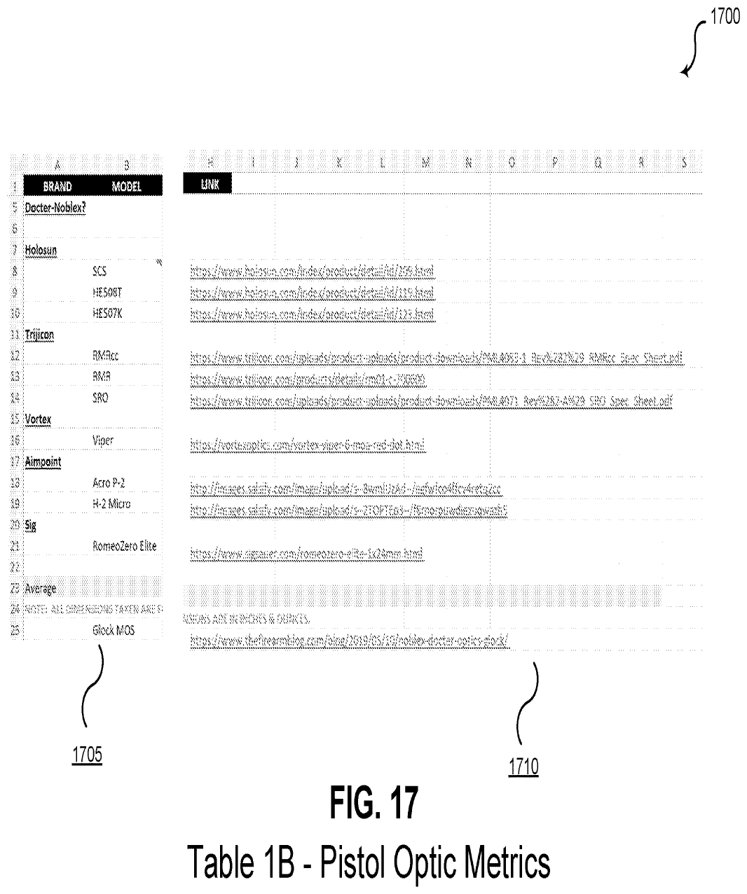

FIG. 17 shows TABLE 1B—Pistol Optic Metrics. Table 1B corresponds to Table 1A and also includes references to some of the aiming devices shown in Table 1A. 1705 shows an indicator to the aiming devices of table 1A. 1710 shows the references.

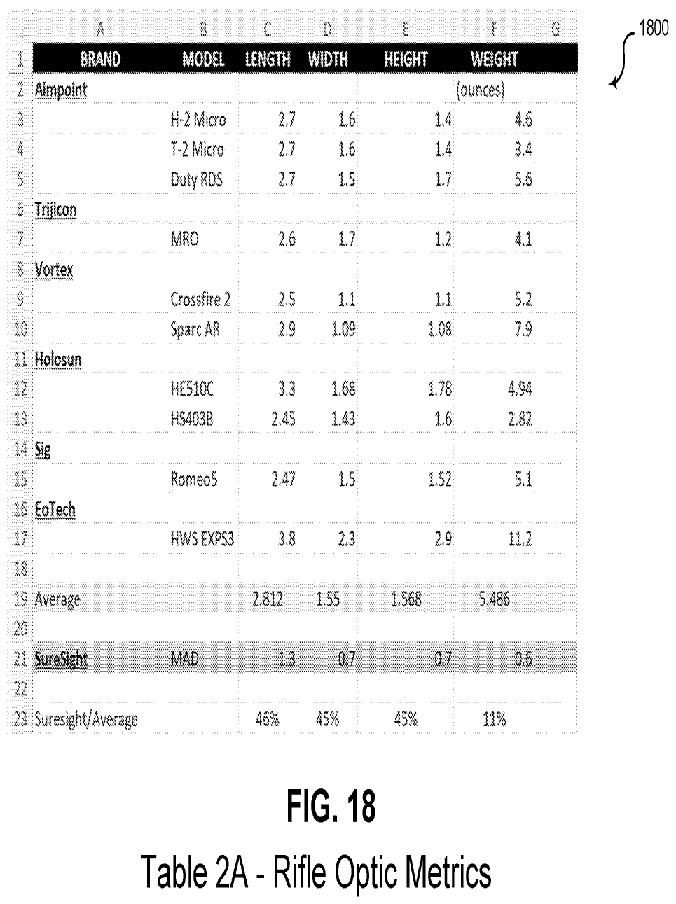

FIG. 18 shows TABLE 2A—Rifle Optic Metrics.

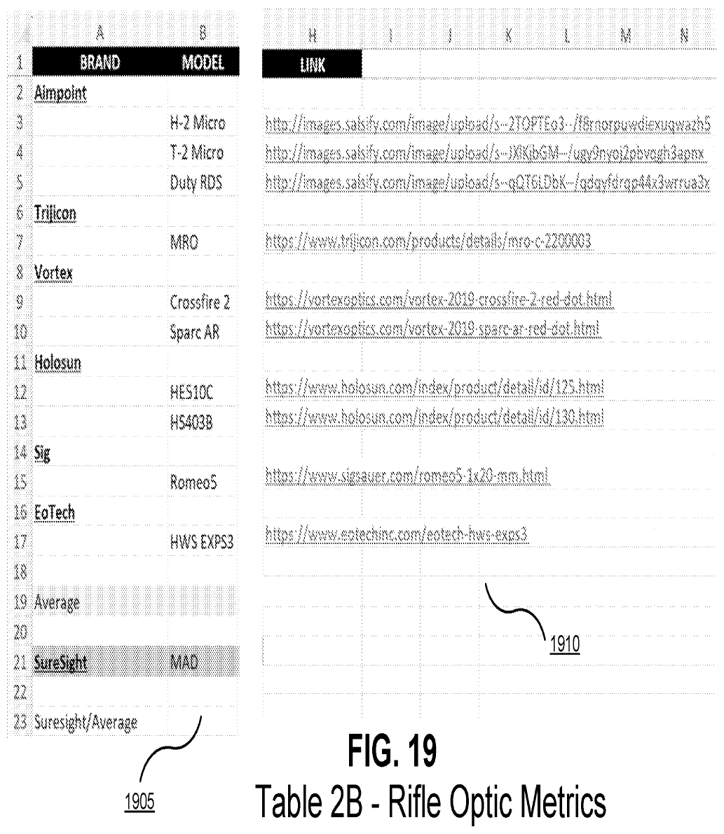

FIG. 19 shows TABLE 2B—Rifle Optic Metrics. Table 2B corresponds to Table 2A and also includes references to some of the aiming devices shown in Table 2A. 1905 shows an indicator to the aiming devices of table 2A. 1910 shows the references.

### Rear Sight Pistol Optic—Miniaturized Aiming Device Comparison & Contrast

The average length of the Leupold Deltapoint Micro, Deltapoint Pro, Holosun SCS, HE508T, HE507K, Trijico RMRcc, RMR, SRO, Vortex Viper, Aimpoint Acro P-2, H-2 Micro, Sig RomeoZero Elite is 1.93″, the average width for these same models is 1.14″, the average height, 1.12″ and the average weight, 1.64 ounces. In contrast, and in at least one embodiment—MAD sight is 1.3″ in length, 0.7″ in width, 0.7″ in height, and 0.6 ounces. In at least one embodiment, a MAD sight is about 64% the average dimension of 10 aiming sights currently on the market, and 37% of the weight of those same sights. In at least one embodiment, a MAD is, on average, 36% smaller and 63% lighter than known aiming devices.

### Front Sight—Miniaturized Aiming Device Comparison & Contrast

To the best of the inventor's knowledge, there is, no aiming device sight for any aimed device that is comparable to any of the MAD embodiments because the MAD is miniaturized to such an extent that they exhibit physical features and characteristics unknown in any other aiming device.

### New Results And Technical Effects

In at least on embodiment and noted below are unexpected and unpredictable new results and technical effects that emerge as a consequence of this miniaturizing the aiming device.

In at least on embodiment, improved target acquisition—wherein the aimer/shooter “finds the ‘red dot’” either during the initial aiming process or recovery after firing one shot and aiming for another shot, is reduced. The lag between drawing or raising a firearm and visually superimposing the sight's ‘red dot’ onto a target is abolished because the red dot is already and always visible to the aimer/shooter, and is substantially on the same plane line as iron sights. This new result solves the technological problems described above in ‘Finding the Red Dot/Reticle’, and are a direct result of miniaturizing the aiming device structural elements.

In at least on embodiment, reduced size means reduced cross sectional area—Because the MAD sight is miniaturized, its cross sectional area as perceived from a shooter/aimer's vantage point is reduced. This means that the sight no longer obstructs as much target, so if the sight is damaged or it's functionality is impaired due to malfunction, a shooter/aimer can still see the target as they would through iron sights. One new result is that when a shooter/aimer is involved in using a firearm in a combat situation, this expanded ability to perceive the environment translates in greater situational awareness. This new result solves the technological problems described above in ‘Relative Size of Both Occluded and Non-Occluded Red Dot Sights’, ‘Problems with Glass Windows: Susceptible to Fracture or Shattering’, ‘Problems with Glass Windows: Window Can Fall Out Completely’, ‘Problems with Glass Windows: Window Tint Distorts Image’, ‘Problems with Glass Windows: Window Tint Inhibits Viewing of the Fixed Post ‘Iron Sight’.

In at least one embodiment Binocular Vision Not Required—In OEG ‘red dot’ sights one eye sees the target, one the reticle (dot), and the brain merges the images. In contrast, as in non-occluded ‘red dot’ sights, due to the small size of the miniaturized MAD aiming device, only one eye is necessary for viewing both the environment/target and the sight's (red) dot at the same time. The technical effect is that this arrangement facilitates for effective aiming, even with only one eye.

In at least on embodiment, miniaturization means that iron sights can be used in case of sight failure—Many red dot sight setups allow for backup notch and post sights to be present as well, but these red dot sight setups typically are not aligned with the backup iron sights. This can be due to the different required viewing angles of seeing aligned iron sights and seeing the dot. Compounding this problem is that most red dot sights project the reticle onto a dichroic mirror. While transparent, it must be tinted with a coating to reflect back light from the emitter. This can make seeing the front sight through the “window” challenging especially under stress When the MAD sight is used with a conventional iron sight, if the MAD sight fails, there is no physical movement required by the shooter/aimer to change the viewing angle of the sights from reticle (as in typical red dot sights) to iron sights. In the event of sight failure, the user simply shifts their focus to see the notch and post sights. One technical effect of miniaturizing the aiming device presented in the instant inventions is that the sights are now so small that if, for any reason, the MAD sight fails, standard iron sights can still be used, without changing the angle of the aimed device relative to the aimer's eyes or the target.

In at least on embodiment Reduced Size Means Reduced Mass—Because the MAD sight is miniaturized, its mass is reduced. This means that (in addition to the reduced size, volume and cross sectional area), it is now practical to deploy this kind of sight on a pistol. OEG aiming sights have heretofore only been used on mortars or rifles or aimed devices that were used with two hands because the OEG is/was relatively large and heavy. Because the MAD is miniaturized and relatively light-in-mass it is now practical to deploy on a pistol. This new result solves the technological problems described above in ‘Relative Size of Both Occluded and Non-Occluded Red Dot Sights’.

In at least on embodiment Reduced Size Means ‘Pistol+MAD Aiming Device’ are holster able—because a MAD aiming device is miniaturized the sight need not excessively protrude or block positioning or deployment when inserting into a standard, non-optics cut holster. In at least one embodiment, this is even if the MAD is mounted in the front sight position. This is unlike any existing single focal plane aiming device. In at least one embodiment, when withdrawing a ‘Pistol+MAD Aiming Device’ from a ‘carry’ position to a ‘ready+aiming’ position, the ‘Pistol+MAD Aiming Device’ are less likely to snag or get caught on clothing or equipment’.

In at least one embodiment In Occluded Embodiment the Aiming Point is Visible in Any Background—In contrast to occluded eye (OEG) red dot-style sights, non-occluded in red dot sights, the reticle can “wash out” in bright light or against bright backgrounds. This can also happen when aiming at something that is similar in color to the aiming reticle. One example that illustrates this phenomenon is when a non-occluded sight using a red dot is aimed at an object in the environment that is also red. The MAD aiming device is far less affected by ambient lighting conditions and allows for the dot to preserve contrast with respect to the environment background in any environment. This is because the background is self-contained, dark, and always in contrast to the reticle. In other words, the dot in the MAD sight is easier to see in bright environments, because it's always on a dark background. This technical effect is that even in the bright light and regardless of lighting conditions, the reticle/dot will be visible. This is different from non-occluded sights, because the reticle is projected on a transparent window. In bright light, this reticle appears dimmer. When aiming at a target with a similar color as the reticle, it will be harder to see and appear dimmer.

In at least one embodiment Improved Power Utilization (II)—One additional new result of above mentioned ‘Aiming Point Visible in Any Background’ new result is that this reduced requirement for brightness means increased battery life in embodiments that use batteries as a power supply.

In at least one embodiment Front Sight Embodiment Allows Targeting with Only One Eye In at least on embodiment, a technical effect of miniaturization is that when the MAD aiming device is deployed using an embodiment that is occluded, a shooter/aimer one can clearly see the reticle and aim a device towards a precise point on the desired target with just one eye, unlike other OEG sights

In at least one embodiment Specialized Training to Use the Sight is Completely Eliminated—Still Another technical effect of miniaturization relates to the requirement for shooter/aimers to specially train using the sight. A biomechanically proper weapon presentation is a physical skill. Repetition and practice is required to achieve a reliable and repeatable draw stroke and point. A proper presentation results in the shooter seeing both his sight and the target. Serious notch and post sight shooters typically require training/retraining when transitioning to red dot sights because of the additional time to learn how to acquire the dot. The MAD sight invention allows for the dot sight to be entirely housed inside an iron sight system which automatically aligns the dot sight and eliminates the necessity for the shooter to learn a new way to point their firearm to acquire the sight. All prior practice is immediately transferable, with no new skills to learn.

In at least one embodiment Constant and Ongoing Visual Feedback on Sight-Target Alignment—Conventional tubeless red-dot sights typically offer little or no feedback about sight-target alignment unless the reticle is visible. Either the aimer/shooter sees the red dot, or they don't. Not so with notch and post sights. When aiming notch and post sights, the shooter always knows where the sights are, and which way to move to align them. One new result of the MAD aiming sight is that it allows for the aimer/shooter to possess and acquire instant and ongoing visual feedback for how to adjust and refine their aim.

In at least one embodiment Special Slide Cuts or Complicating Mounting Options Not Required—One new result of the MAD aiming sight is that it can be mounted in place of existing notch and post iron sights, even replacing the front sight, and similarly adapted for other aiming devices such as rifles, shotguns, bows. In comparison with most red dot sights now used, this technical effect allows the MAD to attach to almost all pistols, even if they do not have an “optics cut”. The vast majority of pistols ever produced do not feature an optics cut. This new result solves the technological problems described above in ‘Pistols Require Permanent Alteration To Mount & Deploy Red Dot Sights’. CLAIMS

I claim:

1-8. (canceled)

9. A method for deploying a miniaturized aiming device, comprising:
obtaining an aimed device, obtaining a miniaturized aiming device (MAD) positioning the miniaturized aiming device on the aimed device, securing the miniaturized aiming device on the aimed device.

10. The method for deploying a miniaturized aiming device of claim 9, further comprising:
wherein the step of obtaining a miniaturized aiming device (MAD) step specifically means obtaining a miniaturized aiming device occluded eye (OEG) sight.

11. The method for deploying a miniaturized aiming device of claim 9, further comprising:
wherein the step of obtaining a miniaturized aiming device (MAD) step specifically means obtaining a reflex aiming device.

12. The method for deploying a miniaturized aiming device of claim 9, further comprising:
wherein the step of obtaining a miniaturized aiming device (MAD) means obtaining a holographic aiming device.

13. The method for deploying a miniaturized aiming device of claim 9, further comprising:
wherein the miniaturized aiming device (MAD) is positioned as a front sight on any firearm.

14. The method for deploying a miniaturized aiming device of claim 9, further comprising:
wherein the miniaturized aiming device (MAD) is positioned as a rear sight on any firearm.

15. The method for deploying a miniaturized aiming device of claim 9, further comprising:
wherein the miniaturized aiming device (MAD) is positioned as a sight on any a manually aimed device.

16. The method for deploying a miniaturized aiming device as recited in claim 9, further comprising: wherein the aimed device is a long gun.

17. The method for deploying a miniaturized aiming device as recited in claim 9, further comprising: wherein the aimed device is a sidearm.

18. A method for using a miniaturized aiming device, comprising:
obtaining an aimed device deployed on an aimed device, looking at or peering through the miniaturized aiming device (MAD), aiming the aimed device by moving the aimed device ‘up and/or down’ and/or ‘left and/or right’ so that an aiming indicator on the miniaturized aiming device is aligned with a target.

19. The method for using a miniaturized aiming device of claim 18, further comprising: activating a trigger mechanism on the miniaturized aiming device.

20. A kit for assembling a miniaturized aiming device, comprising: unassembled components for a miniaturized aiming device wherein the unassembled components are assembled into a miniaturized aiming device.
